(19) United States
(12) Patent Application Publication
(10) Pub. No.: US 2021/0233002 A1
(43) Pub. Date: Jul. 29, 2021

(54) INTEGRATED SCHEDULE MANAGEMENT APPARATUS AND INTEGRATED SCHEDULE MANAGEMENT METHOD

(71) Applicant: Hitachi, Ltd., Tokyo (JP)

(72) Inventor: Hideya YOSHIUCHI, Tokyo (JP)

(73) Assignee: Hitachi, Ltd., Tokyo (JP)

(21) Appl. No.: 17/147,655

(22) Filed: Jan. 13, 2021

(30) Foreign Application Priority Data
Jan. 24, 2020 (JP) 2020-009663

(51) Int. Cl. G06Q 10/06; G06F 9/54

(52) U.S. Cl. CPC G06Q 10/06314; G06F 9/542; G06Q 10/063116

(57) ABSTRACT

It is made possible to adjust schedules of objects to be managed including hardware boxes and individuals including involved parties.

An integrated schedule management apparatus includes: a communication section that receives schedules of a user or/and a hardware box and associated schedules associated with the user or/and the hardware box from one or a plurality of management servers via a network; and an integrated schedule management section that generates an integrated schedule obtained by integrating the schedules received from the one or the plurality of management servers for each of the user or/and the hardware box, and an integrated associated schedule obtained by integrating the associated schedules received from the one or the plurality of management servers for each of the user or/and the hardware box, and that reflects the generated integrated schedule and the generated integrated associated schedule in the one or the plurality of management servers.

### BACKGROUND OF THE INVENTION

### 1. Field of the Invention

The present invention relates to a schedule management technology for humans and hardware boxes.

### 2. Description of the Related Art

The Internet of Things (IoT) technology for connecting every hardware box to the Internet and providing various services is becoming prevalent. While the number of hardware boxes connected to the Internet is rapidly increasing, demand to estimate self-behavioral plans and optimize behaviors by various hardware boxes rises. User's behaviors can be classified into those in a public scene such as those in a school and a company where a user behaves in cooperation with other people and those in a private scene such as those at a home and in holidays where the user has relatively an ample amount of time for which the user can behave freely, and the user normally manages these behaviors as individual schedules. Since time is finite, managing a plurality of schedules often results in occurrence of an event in which the schedules interfere with each other. To avoid the occurrence, a technology for synchronization of a plurality of schedules is proposed (refer to, for example, JP-2011-186986-A). In addition, a technology for integrally managing authentication information to enable logins to a plurality of systems (refer to, for example, JP-2004-234329-A).

The technology described in JP-2011-186986-A is targeted at a mobile terminal such as a cellular telephone and a terminal such as a personal computer (PC), schedules individually managed in the terminals are synchronized, and a correction result of a schedule of one of the terminals is reflected in the other terminal. Furthermore, according to the technology described in JP-2004-234329-A, it is possible to acquire information managed in a plurality of services by integrated management of authentication information for using the plurality of services from a single application. Combining these technologies makes it possible to display information about the schedules individually managed in a plurality of systems in an integrated fashion. However, it is necessary to adjust the schedules by taking into consideration not only individual plans but also schedules of involved parties and schedules of resources such as hardware boxes necessary to execute the schedules.

One object of the present invention is to provide an integrated schedule management apparatus and an integrated schedule management method capable of adjusting schedules of objects to be managed including hardware boxes and individuals including an involved party.

### SUMMARY OF THE INVENTION

An integrated schedule management apparatus according to one aspect of the present invention is configured as an integrated schedule management apparatus including: a communication section that receives schedules of a user or/and a hardware box and associated schedules associated with the user or/and the hardware box from one or a plurality of management servers via a network; and an integrated schedule management section that generates an integrated schedule obtained by integrating the schedules received from the one or the plurality of management servers for each of the user or/and the hardware box, and an integrated associated schedule obtained by integrating the associated schedules received from the one or the plurality of management servers for each of the user or/and the hardware box, and that reflects the generated integrated schedule and the generated integrated associated schedule in the one or the plurality of management servers.

According to one aspect of the present invention, it is possible to adjust schedules of objects to be managed including hardware boxes and individuals including involved parties.

### BRIEF DESCRIPTION OF THE DRAWINGS

FIG. 1 is a block diagram of an integrated schedule management system according to one embodiment;

FIG. 2 is a block diagram depicting an example of configurations of a schedule management server;

FIG. 3 is a block diagram depicting an example of configurations of data managed by the schedule management server;

FIG. 4 is a block diagram depicting an example of configurations of a schedule management terminal;

FIG. 5 is a block diagram depicting an example of configurations of data managed by the schedule management terminal;

FIG. 6 is a block diagram of an integrated schedule management system according to another embodiment;

FIG. 7 is a block diagram depicting an example of configurations of a schedule management terminal;

FIG. 8 is a block diagram of an integrated schedule management system according to another embodiment;

FIG. 9 is a block diagram depicting an example of configurations of an integrated schedule management server;

FIG. 10 is a block diagram depicting an example of configurations of data managed by the integrated schedule management server;

FIG. 11 is a block diagram depicting an example of configurations of an integrated schedule management terminal;

FIG. 12 is a block diagram depicting an example of configurations of data managed by the integrated schedule management terminal;

FIG. 13 is a timeline chart 1 illustrating schedule management processing;

FIG. 14 is a timeline chart 2 illustrating schedule management processing;

FIG. 15 is a timeline chart 3 illustrating schedule management processing;

FIG. 16 is a timeline chart 4 illustrating schedule management processing;

FIG. 17 is a timeline chart 5 illustrating schedule management processing;

FIG. 18 is a user interface 1 illustrating schedule management processing;

FIG. 19 is a user interface 2 illustrating schedule management processing;

FIG. 20 is a user interface 3 illustrating schedule management processing;

FIG. 21 is a user interface 4 illustrating schedule management processing;

FIG. 22 is a user interface 5 illustrating schedule management processing;

FIG. 23 is a user interface 6 illustrating schedule management processing;

FIG. 24 is a user interface 7 illustrating schedule management processing;

FIG. 25 is a user interface 8 illustrating schedule management processing;

FIG. 26 is a user interface 9 illustrating schedule management processing;

FIG. 27 is a flowchart 1 illustrating schedule management processing;

FIG. 28 is a flowchart 2 illustrating schedule management processing; and

FIG. 29 is a user interface 10 illustrating schedule management processing.

### DESCRIPTION OF THE PREFERRED EMBODIMENTS

An embodiment of the present invention will be described hereinafter with reference to the drawings. The following description and the drawing are exemplarily given for describing the present invention and omitted and simplified as appropriate for clarification of the description. The present invention can be implemented in various other modes. Unless specified otherwise, each constituent element may be used either in the singular or in the plural.

In the drawings, a position, a magnitude, a shape, a range, and the like of each constituent element depicted in the drawings do not often represent an actual position, an actual magnitude, an actual shape, an actual range, and the like thereof for facilitating understanding of the invention. For this reason, the present invention is not always limited to the positions, the magnitudes, the shapes, the ranges, and the like disclosed in the drawings.

While various information is often described using any of expressions such as “table” and “list” hereinafter, the information may be expressed in a data structure other than these expressions. To indicate that information does not depend on the data structure, “XX table,” “XX list,” or the like is often rephrased as “XX information.” While expressions such as “identification information,” “identifier,” “name,” “ID,” and “number,” are used at a time of describing identification information, these expressions are replaceable.

In a case in which a plurality of constituent elements have an identical or similar function, the constituent elements are often described with an additional character added to the same reference character to denote each constituent element. It is noted, however, in a case of no need to distinguish these constituent elements, the constituent elements are often described with the additional characters omitted.

Moreover, while processing performed by executing a program is often described in the following description, the program performs specified processing using storage resources (for example, a memory) and/or an interface device (for example, a communication port) as appropriate by being executed by a processor (for example, a central processing unit (CPU) or a graphics processing unit (GPU)); thus, a subject of the processing may be the processor. Likewise, a subject of the processing performed by executing the program may be a controller, an apparatus, a system, a computing machine, or a node having a processor. The subject of the processing performed by executing the program may be a computing section, and the computing section may include a dedicated circuit (for example, a field programmable gate array (FPGA) or an application specific integrated circuit (ASIC)) performing specific processing.

The program may be installed into an apparatus such as a computing machine from a program source. The program source may be, for example, a program distribution server or a computing-machine-readable storage media. In a case in which the program source is the program distribution server, then the program distribution server includes a processor and storage resources storing a program to be distributed, and the processor of the program distribution server may distribute the program to be distributed to other computing machines. Moreover, in the following description, two or more programs may be realized as one program or one program may be realized as two or more programs.

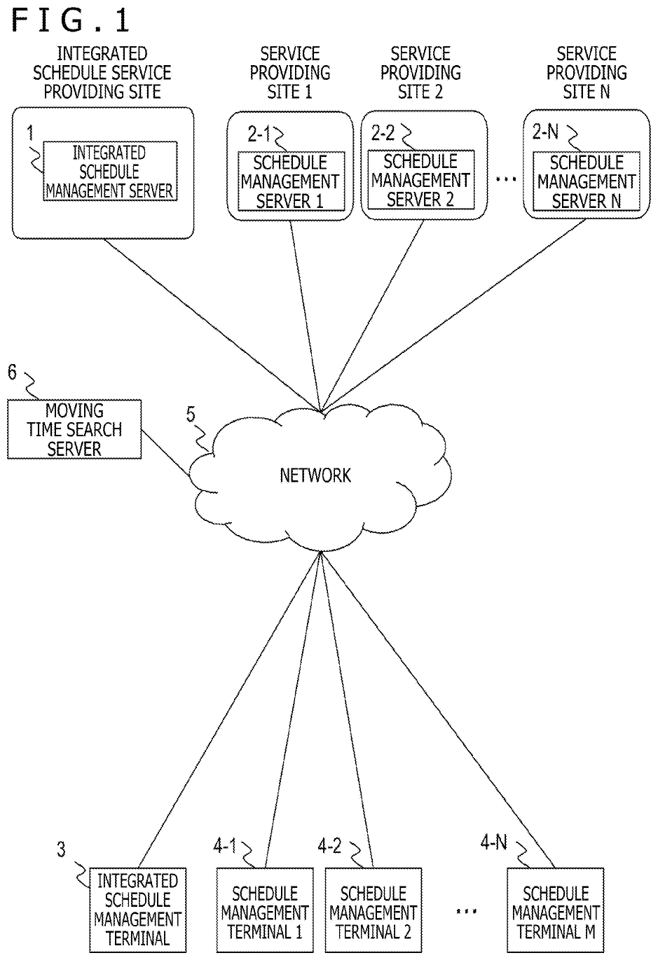

FIG. 1 is an example of configurations of an integrated schedule management system according to the present embodiment. As described hereinafter, the integrated schedule management system according to the present embodiment can be applied to a schedule service for managing and adjusting schedules of a plurality of persons and hardware boxes.

As depicted in FIG. 1, an integrated schedule management system 1000 has an integrated schedule management server 1 that manages all user schedules in an integrated fashion, an integrated schedule management terminal 3 used by a user to operate an integrated schedule, a plurality of schedule management servers 2 (2-1 to 2-N) used by the user to perform schedule management according to individual scenes, schedule management terminals 4 (4-1 to 4-N) used to operate the individual schedule management servers 2, and a moving time search server 6 that calculates a moving path between two locations and required time for the moving path, and these constituent elements are mutually connected by a network 5. The user manages user's own schedules using individual schedule management systems according to classifications such as a public schedule and a private schedule. The integrated schedule management server 1 transmits and receives schedule data to and from the individual schedule management servers 2 (2-1 to 2-N), and realizes integrated schedule management.

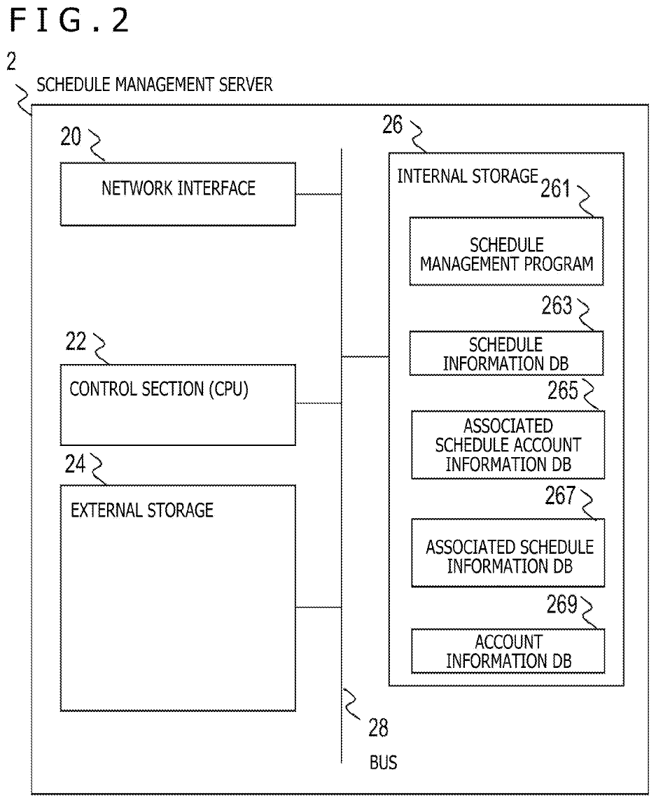

Each apparatus configuring the system will next be described in detail. FIG. 2 depicts an example of apparatus configurations of each schedule management server 2. The schedule management server 2 includes a control section (CPU) 22, an internal storage 26 such as a memory, an external storage 24 such as a hard disk, and a network interface 20 which are connected to a bus 28, and holds communication with outside via the network interface 20. The internal storage 26 includes a schedule management program 261 that realizes management functions such as registration, update, and notification of a schedule, a schedule information database (DB) 263 that manages information such as start time, end time, and a content of the schedule, an associated schedule account information DB 265 that manages account information about persons or hardware boxes associated with the user, an associated schedule information DB 267 that manages schedules of the associated persons or hardware boxes, and an account information DB 269 that manages account information to log in the schedule management server 2. The various databases may be stored in the external storage 24 by taking a system scale, a data volume, a response speed, and the like into consideration. The schedule management program 261 installed into the internal storage 26 reads and writes data to and from these databases. A schedule management function is realized by causing the control section (CPU) 22 to access the schedule management program 261 stored in the internal storage 26.

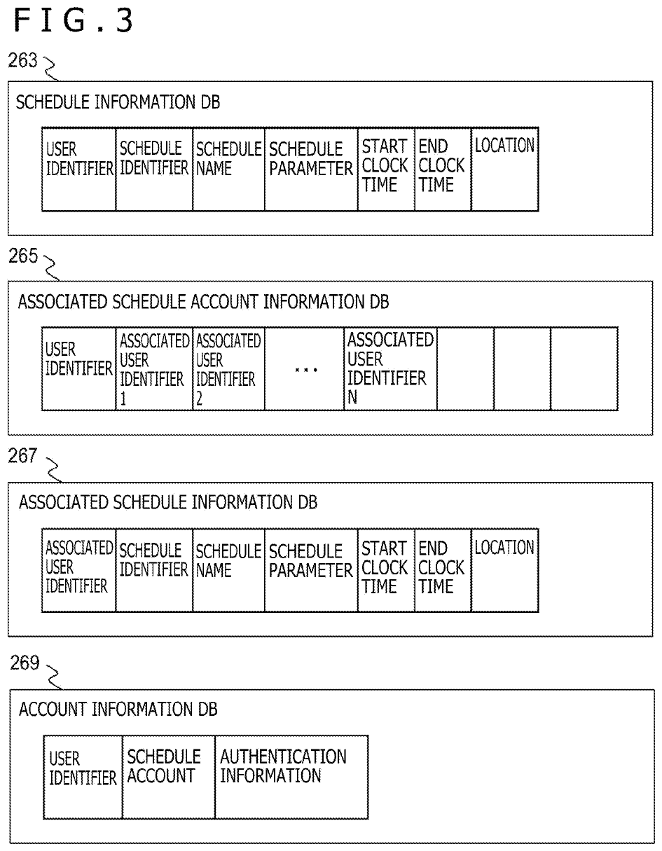

FIG. 3 represents an example of configurations of the various databases present in the internal storage 26 of the schedule management server 2. The schedule information DB 263 is a database that manages information associated with schedules of the user or/and a hardware box, and includes a user identifier uniquely identifying the user, a schedule identifier uniquely identifying a schedule, a schedule name directly representing a content of the schedule, a start clock time and an end clock time of the schedule, a location where the schedule is executed, and a schedule parameter describing features of the schedule. The user identifier may contain an identifier of the hardware box. This respect applies to an integrated user identifier to be described later.

The associated schedule account information DB 265 is a database that manages information for the user to manage schedules of other users or/and hardware boxes associated with the user, and contains a user identifier uniquely identifying the user himself/herself and associated user identifiers uniquely identifying the associated other users. The associated other users are, for example, other staff members in the same department in the same company of the user in a business scene, and family members in a user's home, and are often users having social connections of some sort to the user. The associated other users may include not only the users having social connections of some sort described above but also hardware boxes used by the user. This respect applies to an associated user identifier stored in the integrated schedule management server 1.

The associated schedule information DB 267 is a database that manages schedule information about the associated other users, and contains an associated user identifier uniquely identifying each of the associated users, a schedule identifier uniquely identifying a schedule, a schedule name directly representing a content of the schedule, a start clock time and an end clock time of the schedule, a location where the schedule is executed, and a schedule parameter describing features of the schedule.

The account information DB 269 contains a user identifier, a schedule account, and authentication information as information for the user to log in the schedule management server 2.

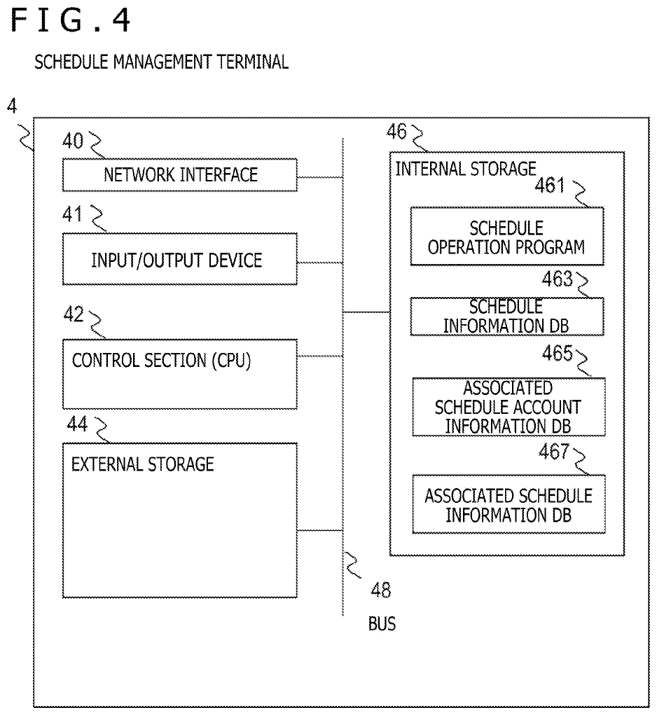

FIG. 4 depicts an example of apparatus configurations of each schedule management terminal 4. The schedule management terminal 4 includes a control section (CPU) 42, an internal storage 46 such as a memory, an external storage 44 such as a hard disk, and a network interface 40 which are connected to a bus 48, and holds communication with outside via the network interface 40. Furthermore, an input/output device 41 such as a keyboard and a display for the user to variously operate schedules is connected to the bus 48. The internal storage 46 includes a schedule operation program 461 that realizes management functions such as registration, update, and notification of a schedule, a schedule information database (DB) 463 that manages information such as start time, end time, and a content of the schedule, an associated schedule account information DB 465 that manages account information about persons and hardware boxes associated with the user, and an associated schedule information DB 467 that manages schedules of the associated persons and hardware boxes. The various databases may be stored in the external storage 44 by taking a system scale, a data volume, a response speed, and the like into consideration. The schedule operation program 461 installed into the internal storage 46 reads and writes data to and from these databases. The schedule management terminal 4 provides schedule management functions to the user by causing the control section (CPU) 42 to access the schedule operation program 461 stored in the internal storage 46.

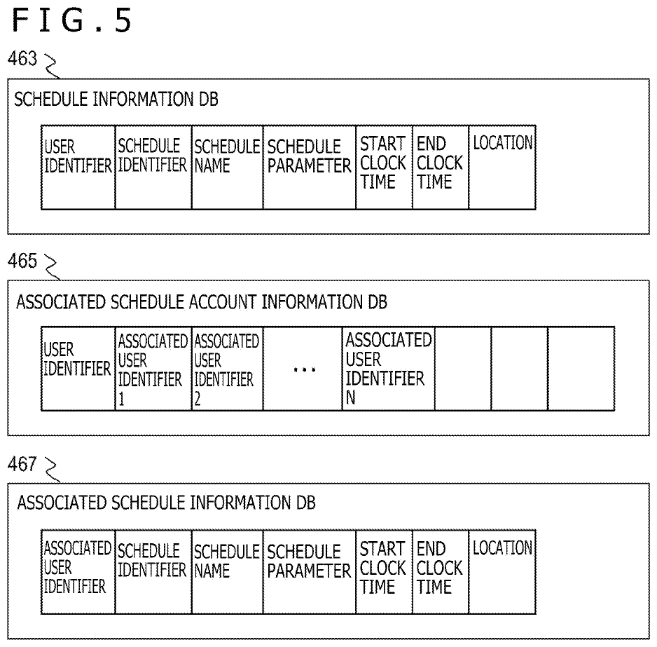

FIG. 5 represents an example of configurations of the databases present in the internal storage 46 of the schedule management terminal 4. Basic functions of the schedule management terminal 4 are to acquire data associated with a schedule from the schedule management server 2, to display the data on a screen, to perform an operation such as change and deletion of the schedule, and to reflect latest data in the schedule management server. Since configurations of the data managed by the schedule management terminal 4 are identical to those managed by the schedule management server 2, the data configurations are not described in detail.

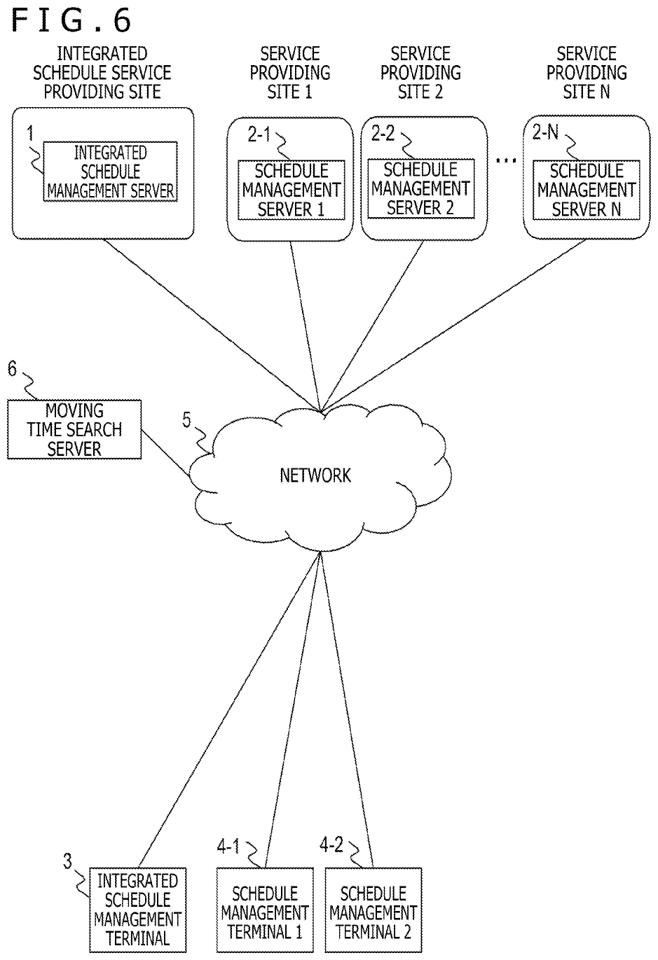

FIG. 6 is another example of configurations of the integrated schedule management system. A mobile terminal such as a smartphone is often used lately as the schedule management terminal 4. Activating a plurality of schedule management programs on a single terminal makes it possible for the plurality of schedule management servers (2-1 to 2-N) to be operated with fewer schedule management terminals 4 (4-1 and 4-2).

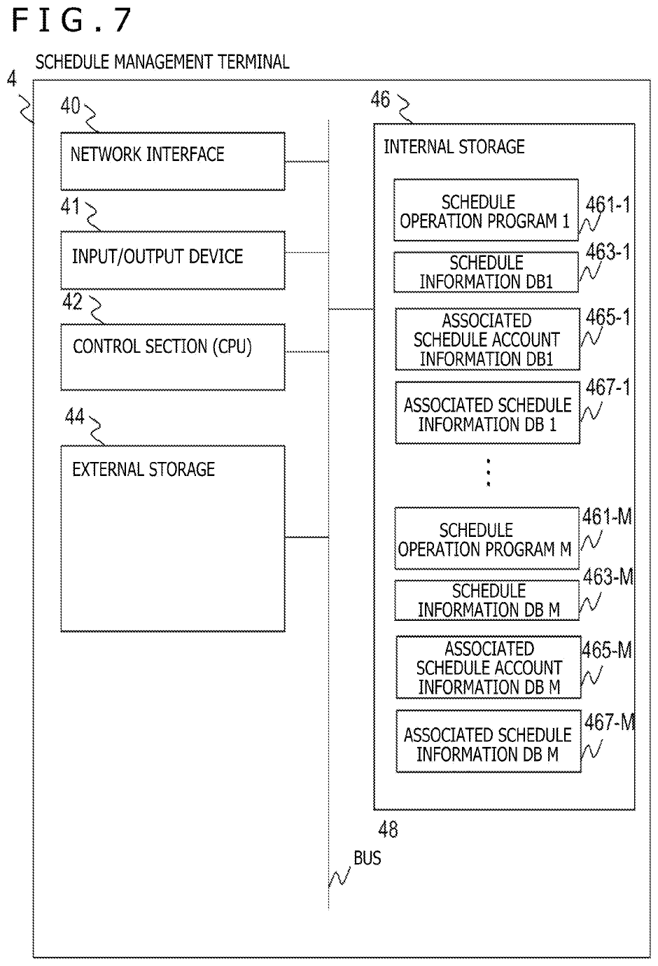

FIG. 7 depicts configurations of the schedule management terminal 4 in such system configurations, and a plurality of schedule operation programs (461-1 to 461-M) operate in the internal storage 46. Since the schedule management servers (2-1 to 2-N) run as independent systems, the schedule operation programs (461-1 to 461-M) individually manage associated databases (463-1 to 463-M, 465-1 to 465-M, and 467-1 to 467-M).

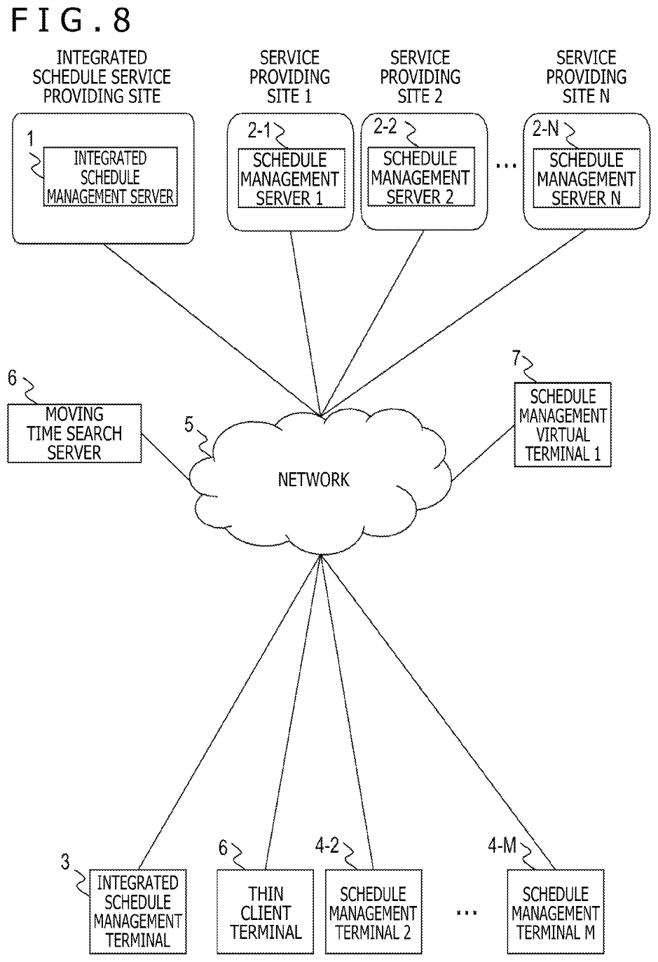

Furthermore, a terminal used by the user is often provided as a combination of a virtual PC and a thin client for purposes of data protection in the business scene. FIG. 8 depicts configurations of an integrated schedule management system including a schedule management virtual terminal 7 and a thin client 6. The schedule management virtual terminal 7 is virtualization of hardware box configurations of the schedule management terminal 4 and identical in configurations to the schedule management terminal 4; thus, the schedule management virtual terminal 7 is not described herein.

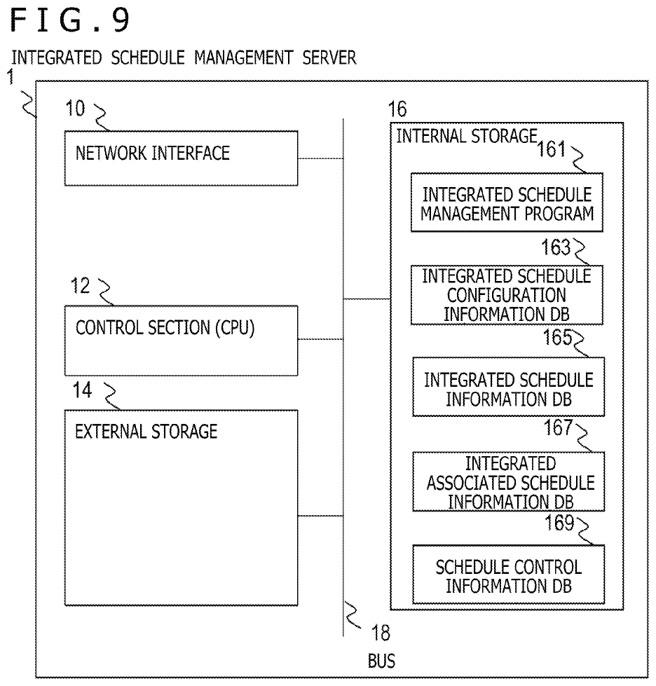

FIG. 9 depicts an example of apparatus configurations of the integrated schedule management server 1. The integrated schedule management server 1 includes a control section (CPU) 12, an internal storage 16 such as a memory, an external storage 14 such as a hard disk, and a network interface 10 which are connected to a bus 18, and holds communication with outside via the network interface 10. The internal storage 16 includes an integrated schedule management program 161 that provides integrated schedule management functions. The integrated schedule management program 161 is installed into the external storage 14 and started up by the control section (CPU) 12 when the system starts running. The integrated schedule management server 1 includes, in addition to this program, an integrated schedule configuration information DB 163 that manages configurations of an integrated schedule, an integrated schedule information DB 165 that manages pieces of integrated schedule information, an integrated associated schedule information DB 167 that manages schedules of involved parties managed by the schedule management servers (2-1 to 2-N) in an integrated fashion, and a schedule control information DB 169 that controls display and notification methods of the integrated schedule on or in the other schedule management servers 2. These databases may be stored in the external storage 14 by taking a system scale, a data volume, a response speed, and the like into consideration. The integrated schedule management program 161 installed into the internal storage 16 reads and writes data to and from these databases. The integrated schedule management server 1 executes integrated schedule management processing by causing the control section (CPU) 12 to access the integrated schedule management program 161 stored in the internal storage 16.

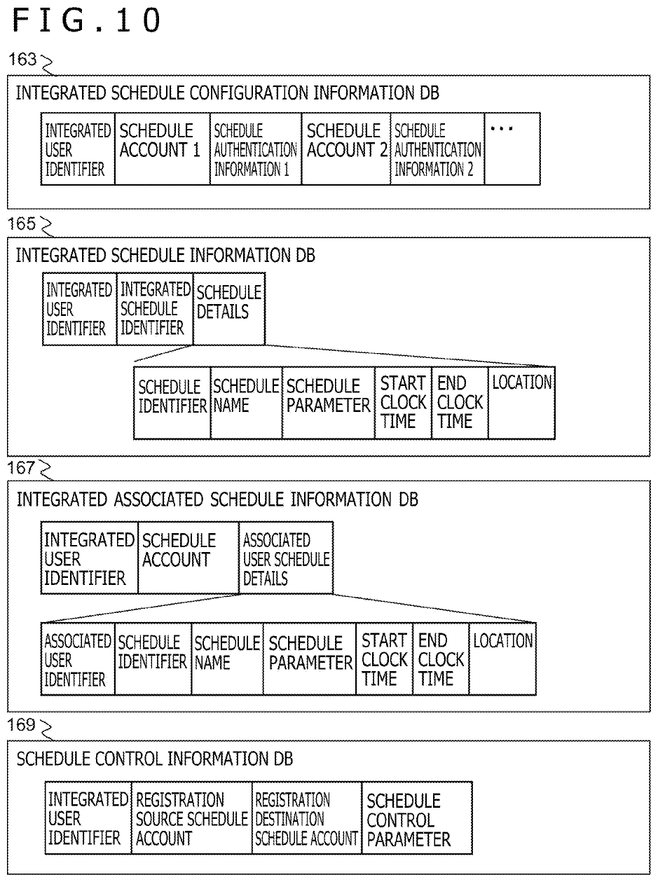

FIG. 10 represents an example of configurations of the various databases present in the internal storage 16 of the integrated schedule management server 1. The integrated schedule configuration information DB 163 is a database that manages account information about the individual schedule management services used by the user, and that manages integrated user identifiers each uniquely identifying the user within the integrated schedule system and pairs of schedule accounts and schedule authentication information necessary to access the individual schedule management servers as many as the schedule management services used by the user.

The integrated schedule information DB 165 is a database that manages schedule information managed by the schedule management servers 2 in an integrated fashion, and contains the integrated user identifier described above, an integrated schedule identifier uniquely identifying an integrated schedule within the system, and schedule details. The schedule details are detailed information about the schedule and a content thereof is similar to that of the schedule information DB 263 in the schedule management server 2. This is because part of schedule registration processing by the integrated schedule management server 1 is executed by collecting schedule information in the individual schedule management servers 2. The schedule details contain a schedule identifier, a schedule name directly representing a content of the schedule, a start clock time and an end clock time of the schedule, a schedule execution location, and an optional schedule parameter describing the schedule details. In a case in which the integrated schedule information is registered on the basis of the schedule information in the schedule management servers 2, values of items of the same names in the schedule information DBs 263 in the schedule management servers 2 are used as the items in the schedule details by copying the values. In a case in which the integrated schedule information is registered by an operation of the integrated schedule management terminal 3 without dependence on the information in the schedule management servers 2, a null is set to the schedule identifier in the schedule details.

The integrated associated schedule information DB 167 is a database that manages the associated schedule information managed by the schedule management servers 2 in an integrated fashion, and contains the integrated user identifier described above, schedule accounts used at the time of accessing the schedule management servers 2 and acquiring the associated schedule information, and associated schedule details. A content of the associated schedule details is similar to that of the associated schedule information DB 267 in the schedule management server 2. This is because associated schedule registration processing by the integrated schedule management server 1 is executed by collecting associated schedule information in the individual schedule management servers 2. The associated schedule details contain an associated user identifier, a schedule identifier, a schedule name directly representing a content of the schedule, a start clock time and an end clock time of the schedule, a schedule execution location, and an optional schedule parameter describing the schedule details. Values of items of the same names in the associated schedule information DBs 267 in the schedule management servers 2 are used as the items in the associated schedule details by copying the values.

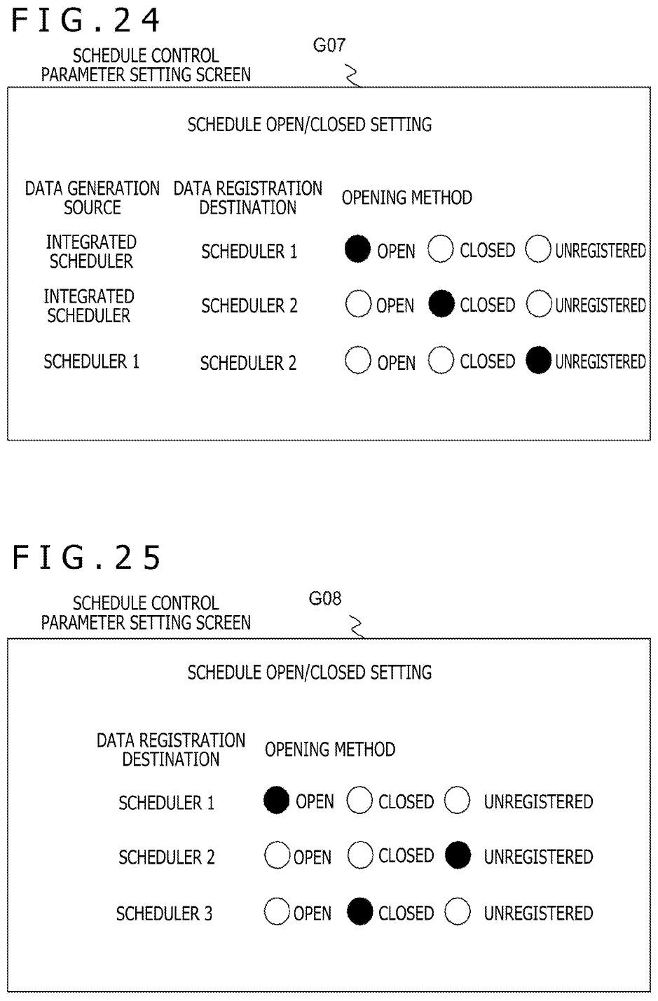

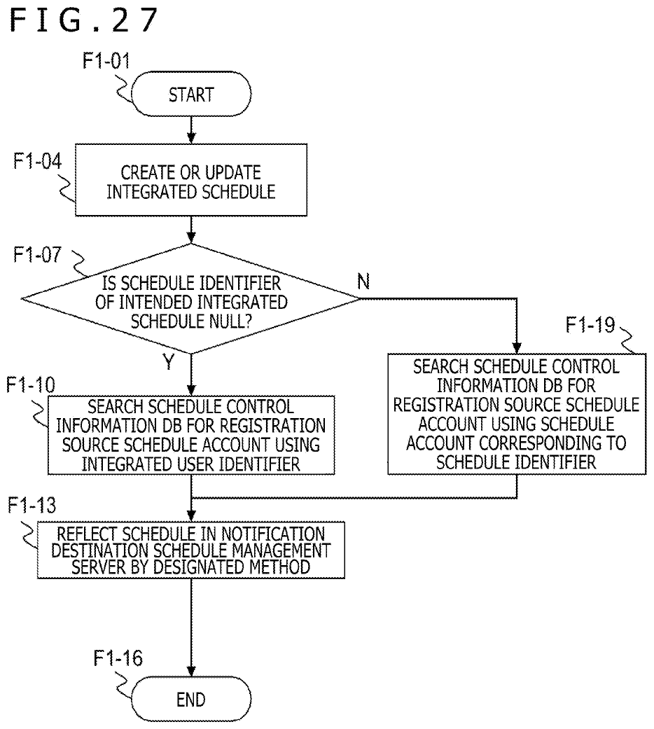

The schedule control information DB 169 is a database that manages a parameter for controlling processing at a time of reflecting a result of an operation on the integrated schedule carried out on the integrated schedule management server 1 in the schedule management servers 2, and contains the integrated user identifier described above, a registration source schedule account used at a time of registering the schedule, a schedule registration destination schedule account, and a schedule control parameter. Details of the control using the schedule control parameter will be described with reference to FIGS. 24 and 27.

FIG. 11 depicting an example of apparatus configurations of the integrated schedule management terminal 3. The integrated schedule management terminal 3 is configured with a control section (CPU) 32, an internal storage 36 such as a memory, an external storage 34 such as a hard disk, and a network interface 30 which are connected to a bus 38, and holds communication with outside via the network interface 30. Furthermore, an input/output device 31 such as a keyboard and a display for the user to variously operate schedules is connected to the bus 38. The internal storage 36 contains an integrated schedule operation program 361 that provides integrated schedule management functions. The integrated schedule operation program 361 is installed into the external storage 34 and started up by the control section (CPU) 32 when the system starts running. The integrated schedule management terminal 3 includes, in addition to this program, an integrated schedule configuration information DB 363 that manages configurations of the integrated schedule, an integrated schedule information DB 365 that manages the pieces of integrated schedule information, an integrated associated schedule information DB 367 that manages the schedules of involved parties managed by the schedule management servers 2 (2-1 to 2-N) in an integrated fashion, and a schedule control information DB 369 that controls the display and notification methods of the integrated schedule on or in the other schedule management servers 2. These databases may be stored in the external storage 34 by taking a system scale, a data volume, a response speed, and the like into consideration. The integrated schedule operation program 361 installed into the internal storage 36 reads and writes data to and from these databases. The integrated schedule management terminal 3 executes integrated schedule management processing by causing the control section (CPU) 32 to access the integrated schedule operation program 361 stored in the internal storage 36.

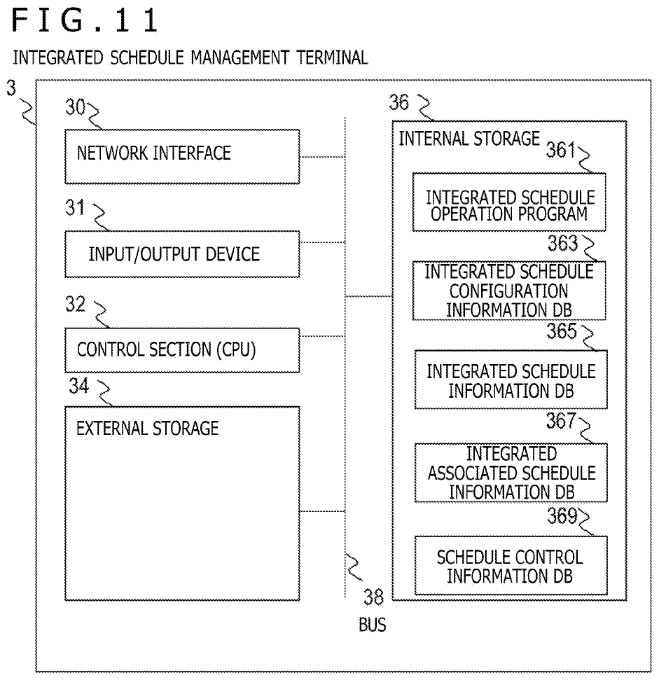

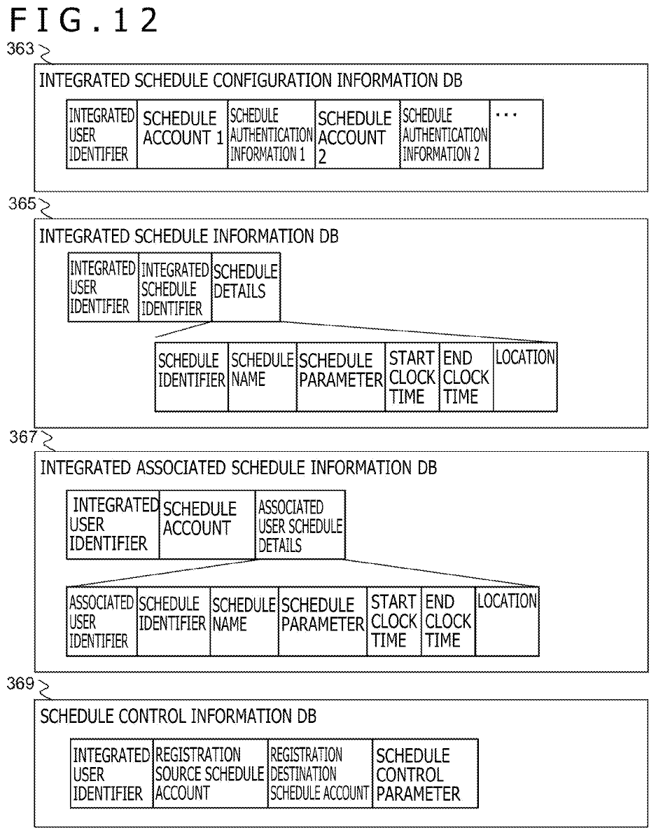

FIG. 12 represents an example of configurations of the databases present in the internal storage 36 of the integrated schedule management terminal 3. Basic functions of the integrated schedule management terminal 3 are to acquire data associated with the integrated schedule from the integrated schedule management server 1, to display the data on a screen, to perform an operation such as change and deletion of the schedule, and to reflect latest data in the schedule management servers 2. Since configurations of the data managed by the integrated schedule management terminal 3 are identical to those managed by the integrated schedule management server 1, the data configurations are not described in detail.

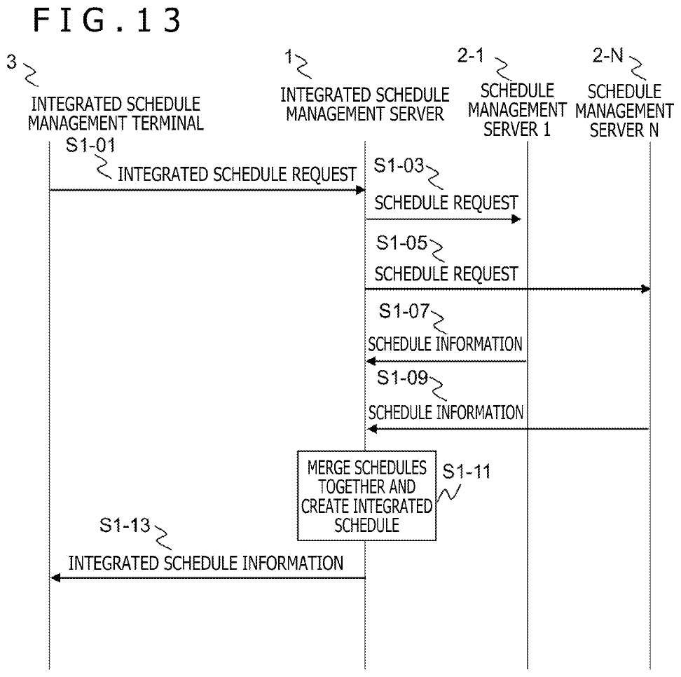

Subsequently, overall operations of the integrated schedule management system according to the present embodiment will be described. First, using a timeline chart of FIG. 13, processing for collecting schedules from the schedule management servers 2 (2-1 to 2-N) and generating an integrated schedule will be described.

In response to an operation from the user, the integrated schedule management terminal 3 transmits a message of an integrated schedule request to the integrated schedule management server 1 (S1-01). The integrated schedule request contains the integrated user identifier in the integrated schedule configuration information DB 363. The integrated schedule management server 1 receiving the integrated schedule request searches the integrated schedule configuration information DB 163 using the integrated user identifier contained in the message, and acquires schedule accounts and schedule authentication information for the schedule management servers 2 (2-1 to 2-N) corresponding to the integrated user identifier. The integrated schedule management server 1 acquiring the accounts and the authentication information for the schedule management servers 2 (2-1 to 2-N) transmits a schedule request to the schedule management servers 2 (2-1 to 2-N) (S1-03 and S1-05). The schedule request contains the schedule account and schedule authentication information to log in each of the schedule management servers 2 (2-1 to 2-N).

Each of the schedule management servers 2 (2-1 to 2-N) receiving the schedule request searches the account information DB 269 using the schedule account and the schedule authentication information contained in the message, and acquires a user identifier corresponding to the account after confirming that the authentication information is correct. Each schedule management server 2 searches the schedule information DB 263 using the acquired user identifier, and transmits all schedule information corresponding to the user identifier to the integrated schedule management server (S1-07 and S1-09).

Upon receiving the schedule information from all intended schedule management servers 2 (2-1 to 2-N), the integrated schedule management server 1 merges the all received schedule information together to create an integrated schedule (S1-11), and transmits the created integrated schedule to the integrated schedule management terminal 3 as a response (S1-13).

A state of generating the integrated schedule information from the schedule information will be described with reference to FIG. 20. It is assumed that user's schedules are managed by the schedule management server 1 (2-1) and the schedule management server 2 (2-2) as a content of, for example, the user's schedule in a company displayed on a schedule display screen 1 (G03-01) and as a content of the user's private schedule displayed on a schedule display screen 2 (G03-02). When the integrated schedule is generated from these two schedules by processing depicted by the timeline chart of FIG. 13, a schedule on an integrated schedule display screen (G03-03) is obtained. The integrated schedule has a content that contains all schedules on the schedule display screen 1 (G03-01) and the schedule display screen 2 (G03-02).

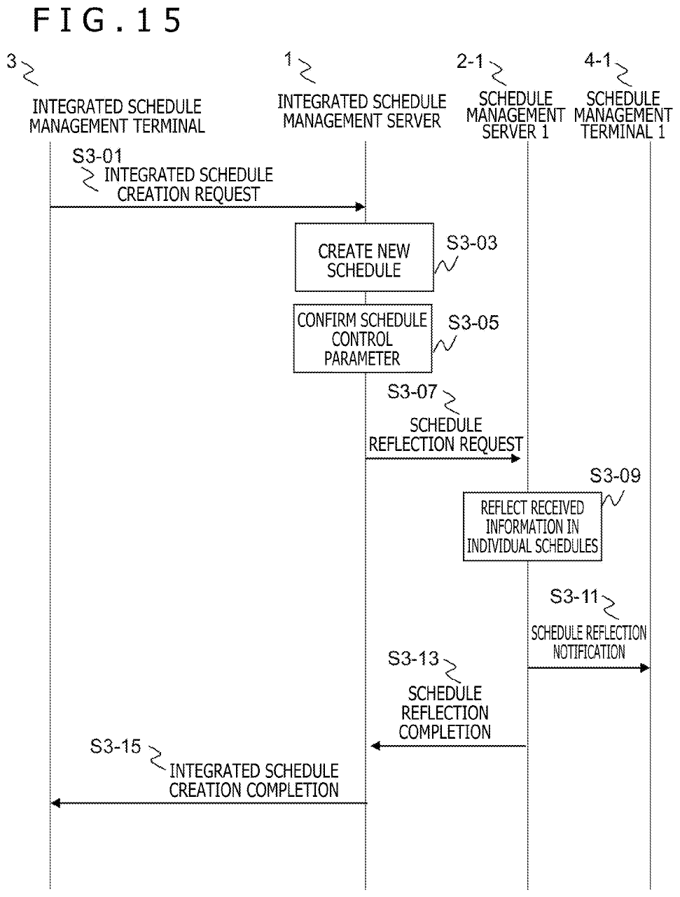

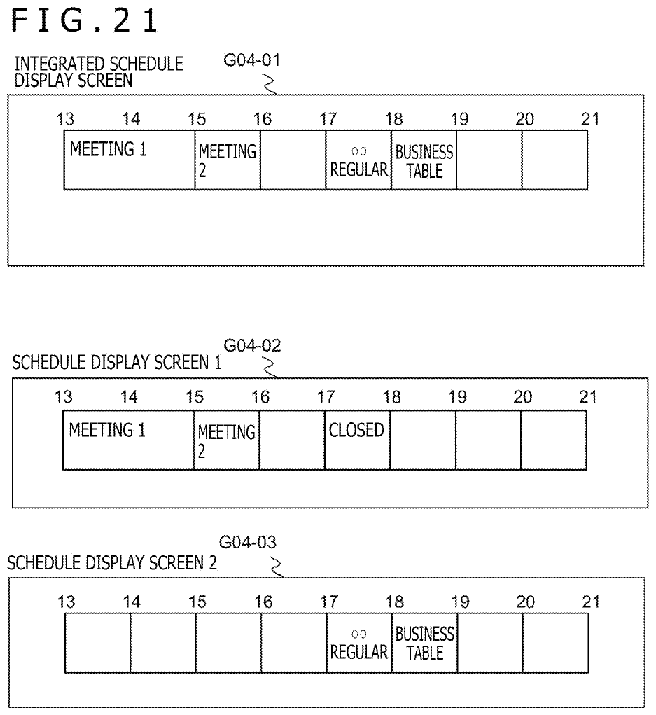

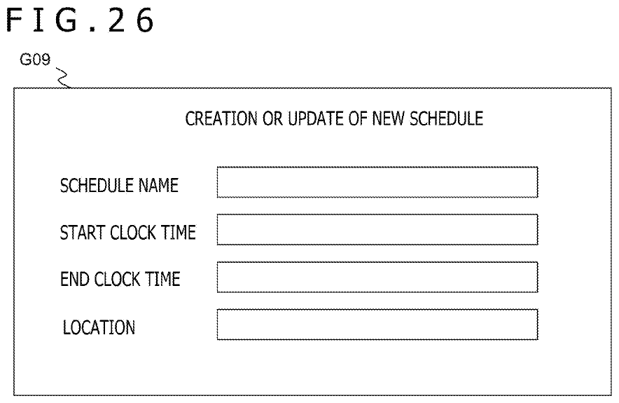

Next, a method of newly creating an integrated schedule using the integrated schedule management terminal 3 will be described with reference to a timeline chart of FIG. 15. In response to an operation from the user, the integrated schedule management terminal 3 receives an input of information associated with an own schedule of the user. Information necessary to create a schedule includes a schedule name, a start clock time, an end clock time, and a location as depicted in FIG. 26. The integrated schedule management terminal 3 receiving the input from the user transmits a message containing an integrated schedule generation request to the integrated schedule management server 1 (S3-01). The integrated schedule generation request contains the schedule name, the start time, the end time, and the location as information. In response to the integrated schedule generation request, the integrated schedule management server 1 generates an integrated schedule (FIG. 21, G04-01) using the information contained in the message, and registers the integrated schedule in the integrated schedule information DB 365 (S3-03). At a time of registering the integrated schedule, the integrated schedule management server 1 newly generates a schedule identifier.

A display method of the newly generated integrated schedule on each of the schedule management terminals 4 (4-1 to 4-N) is controlled by the schedule control parameter contained in the schedule control information DB 169 of the integrated schedule management server 1. It is assumed that the integrated schedule in the name of “○○ regular” is created on the integrated schedule display screen G04-01 of FIG. 21. It is considered that the method of displaying this integrated schedule on each of the schedule management terminals 4 (4-1 to 4-N) includes displaying the integrated schedule as it is as in a schedule display screen 1 (G04-02) or displaying the integrated schedule with a content set closed as in a display screen 2 (G04-03).

The schedule control parameter is set by a schedule control parameter setting screen G07 as depicted in FIG. 24. As a control method, an opening method is set by selecting one of open, closed, and unregistered for each of a schedule data generation source and a schedule data registration destination. In a case of setting unregistered as a notification control method, the integrated schedule management server 1 does not transmit an integrated schedule update request to each of the schedule management servers 2. Furthermore, not only the integrated schedule management server 1 but also any of the schedule management servers 2 can be registered as the data generation source. This is because an integrated schedule is often generated on the basis of schedule data newly created by the schedule management server 2. The schedule data created by the schedule management server 2 has a schedule identifier created by the schedule management server 2 and managed in the schedule information DB 263, and this value is managed as the schedule identifier in the integrated schedule information DB 165 of the integrated schedule management server 1; thus, the data generation source can be thereby identified.

In a case in which a control parameter is to set to individual integrated schedule data in addition to the schedule display control based on the data generation source, a schedule control parameter setting screen associated with the integrated schedule data is used as depicted in FIG. 25. With this method, it is possible to set only a data registration destination and an opening method.

The integrated schedule management server 1 searches the schedule control information DB 169 and acquires a control parameter for reflecting the integrated schedule in the individual schedule management servers 2 (S3-05). In a case in which the value of the schedule control parameter is other than “unregistered,” the integrated schedule management server 1 transmits a schedule reflection request to the individual schedule management server 2 (2-1) to request the schedule management server 2 to update the schedule (S3-07). A schedule update request contains the schedule identifier, the schedule name, the start clock time, the end clock time, and the location. In a case in which the value of the schedule control parameter is “unregistered,” the integrated schedule management server 1 does not transmit the schedule reflection request.

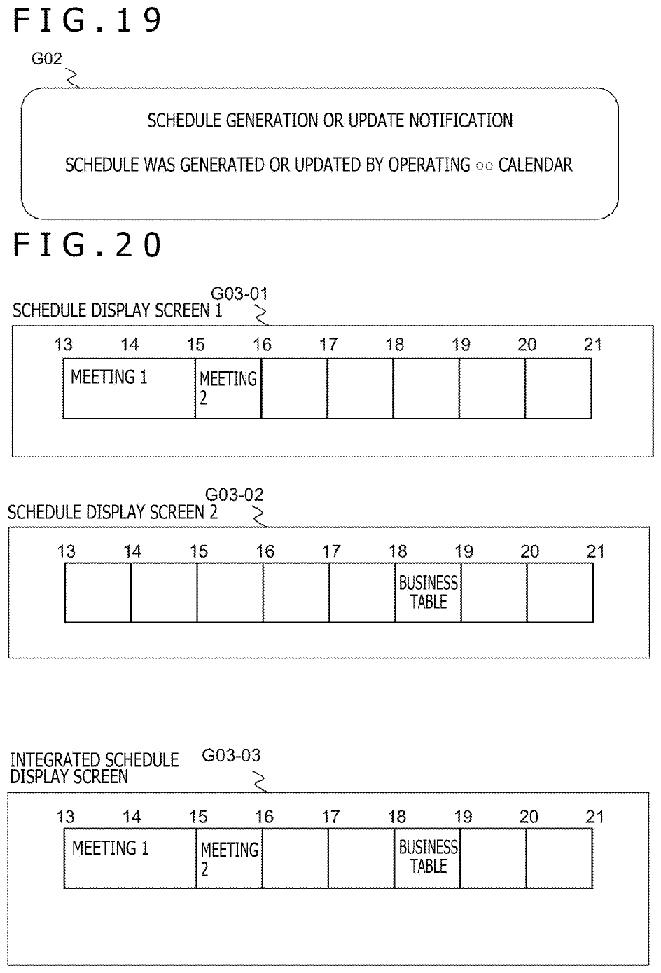

In response to the schedule update request, the schedule management server 2 (2-1) registers the schedule information in the schedule information DB 463 using the received information (S3-09). The schedule management server 2 (2-1) then notifies the schedule management terminal 4 (4-1) of schedule update (S3-11). A content of the notification to the schedule management terminal 4 (4-1) varies depending on whether the content of the schedule control parameter is open or closed. In a case in which the schedule control parameter indicates open, the content of the notification to the schedule management terminal 4 (4-1) contains a calendar name of a generation source that is a source of the schedule update, the schedule name, the start clock time, and the end clock time, as depicted in G01 of FIG. 18. In contrast, in a case in which the schedule control parameter indicates closed, the notification content contains only the calendar name of the generation source that is the source of the schedule update, as depicted in G02 of FIG. 19. After transmitting the schedule update notification to the schedule management terminal 4 (4-1), the schedule management server 2 (2-1) transmits schedule reflection completion to the integrated schedule management server 1 (S3-13). In response to the schedule reflection completion, the integrated schedule management server 1 transmits integrated schedule creation completion to the integrated schedule management terminal 3 (S3-15).

FIG. 27 is a flowchart illustrating schedule control parameter processing procedures at the time of creating or updating the integrated schedule. Upon detecting that an integrated schedule is newly created or updated (F01-04), the integrated schedule management server 1 searches the integrated schedule information DB 165 for items of the intended integrated schedule, and determines whether the value of the schedule identifier contained in the schedule details is null (F01-07). In a case in which the schedule identifier is null (F01-07: Yes), the integrated schedule is a newly created integrated schedule by an operation of the integrated schedule management terminal 3. The integrated schedule management server 1, therefore, searches the schedule control information DB 169 for the registration source user account using the integrated user identifier as a search key, and acquires the schedule control parameter (F01-10).

In a case in which the schedule identifier is not null (F01-07; No), the integrated schedule is an integrated schedule created on the basis of the schedule information collected from another schedule management server 2. The integrated schedule management server 1, therefore, searches the schedule control information DB 169 for the registration source user account using the schedule account in the schedule management server 2 associated with the schedule identifier, and acquires the schedule control parameter (F01-19). After acquiring the schedule control parameter by any of the methods, the integrated schedule management server 1 requests the schedule management server 2 that is a notification destination to reflect the schedule by the method designated by the schedule control parameter (F01-13).

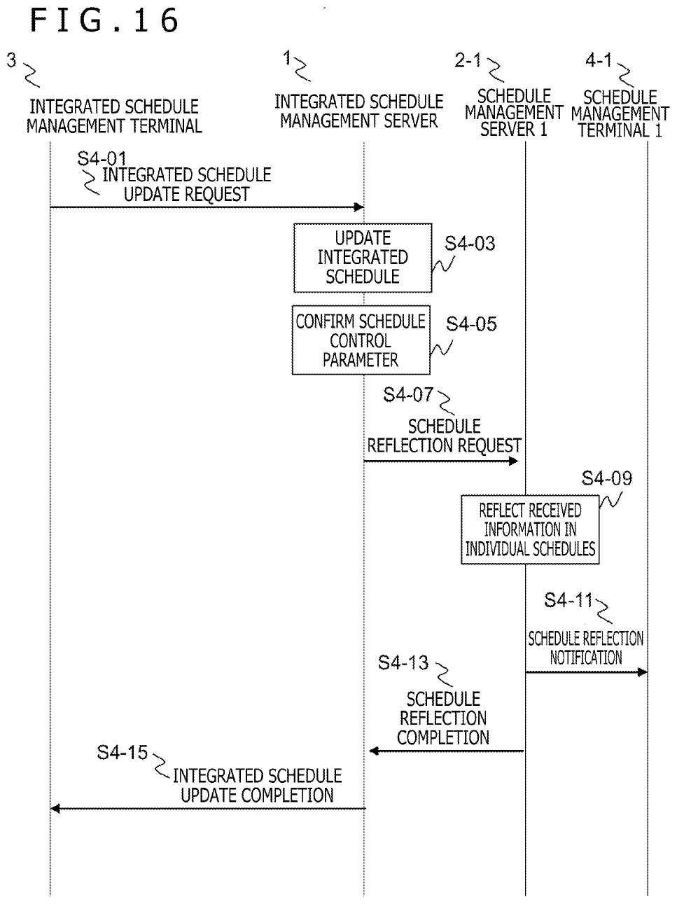

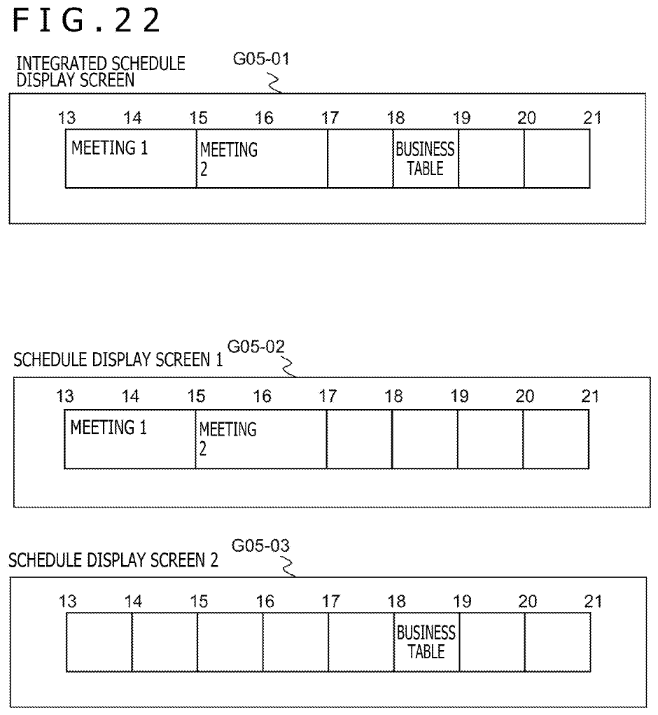

The integrated schedule can be not only newly created but also acquired by updating an existing schedule. It is assumed that the integrated schedule depicted on the integrated schedule display screen G03-03 of FIG. 20 is updated to an integrated schedule display screen G05-01 of FIG. 22. In this case, the end clock time of a meeting 2 is corrected from 16:00 to 17:00. Integrated schedule update processing will be described with reference to a timeline chart of FIG. 16.

Integrated schedule update is started by user's operating the integrated schedule management terminal 3 and inputting necessary information for schedule update. The information necessary to the schedule update is similar to that at the time of creating the integrated schedule, as depicted in G09 of FIG. 26. A difference of the integrated schedule update from the time of newly creating an integrated schedule is that the already present schedule identifier of the schedule is continuously used at the time of updating the existing schedule while the schedule identifier is newly generated at the time of newly generating the schedule. Since the subsequent integrated schedule update processing is similar to the integrated schedule generation processing, description thereof is omitted.

In the case of creating or updating the integrated schedule, it is often necessary to take into consideration not only the own schedule of the user but also schedules of involved parties. The schedules of the involved parties are managed as a group schedule that can be permitted to be viewed only as the schedules of the associated users in the schedule management servers 2 (2-1 to 2-N).

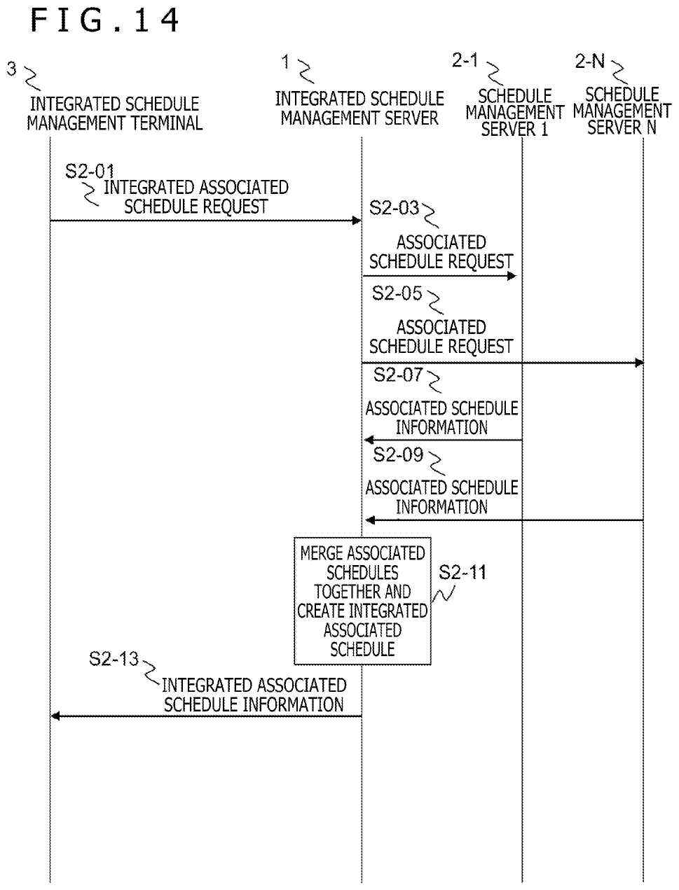

A timeline chart of FIG. 14 depicts processing for integrating associated schedules managed by the schedule management servers 2 (2-1 to 2-N) and managing an integrated result as an integrated associated schedule. Processing for generating and displaying an integrated associated schedule is started by transmitting a message of an integrated associated schedule request to the integrated schedule management server 1 from the integrated schedule management terminal 3 (S2-01). The integrated associated schedule request contains the integrated schedule identifier in the integrated schedule configuration information DB 363. In response to the integrated associated schedule request, the integrated schedule management server 1 searches the integrated schedule configuration information DB 163 using the integrated user identifier contained in a message, and acquires schedule accounts and schedule authentication information for the schedule management servers 2 (2-1 to 2-N) corresponding to the integrated user identifier.

Upon acquiring the accounts and the authentication information for the schedule management servers 2 (2-1 to 2-N), the integrated schedule management server 1 transmits a message of an associated schedule request to the schedule management servers 2 (2-1 to 2-N) (S2-03 and S2-05). The associated schedule request contains the schedule account and the schedule authentication information to log in each of the schedule management servers 2 (2-1 to 2-N). In response to the associated schedule request, each of the schedule management servers 2 (2-1 to 2-N) searches the account information DB 269 using the schedule account and the schedule authentication information contained in the message, and acquires a user identifier corresponding to the account after confirming that the authentication information is correct. Each of the schedule management servers 2 searches the associated schedule account information DB 265 using the acquired user identifier, and acquires a list of associated user identifiers representing the involved parties viewed by the user in the schedule management server 2.

Next, for the acquired all associated user identifiers, each schedule management server 2 searches the schedule information DB 263 to acquire all schedule information corresponding to the associated user identifiers, and transmits the schedule information to the integrated schedule management server 1 as associated schedule information (S2-07 and S2-09). The associated schedule information contains schedule accounts, schedule identifiers, schedule names, start clock times, end clock times, and locations. Upon receiving the associated schedule information from all of the intended schedule management servers 2 (2-1 to 2-N), the integrated schedule management server 1 merges all the received associated schedule information together to create an integrated schedule (S2-11), and transmits the created integrated associated schedule to the integrated schedule management terminal 3 as a response (S2-13).

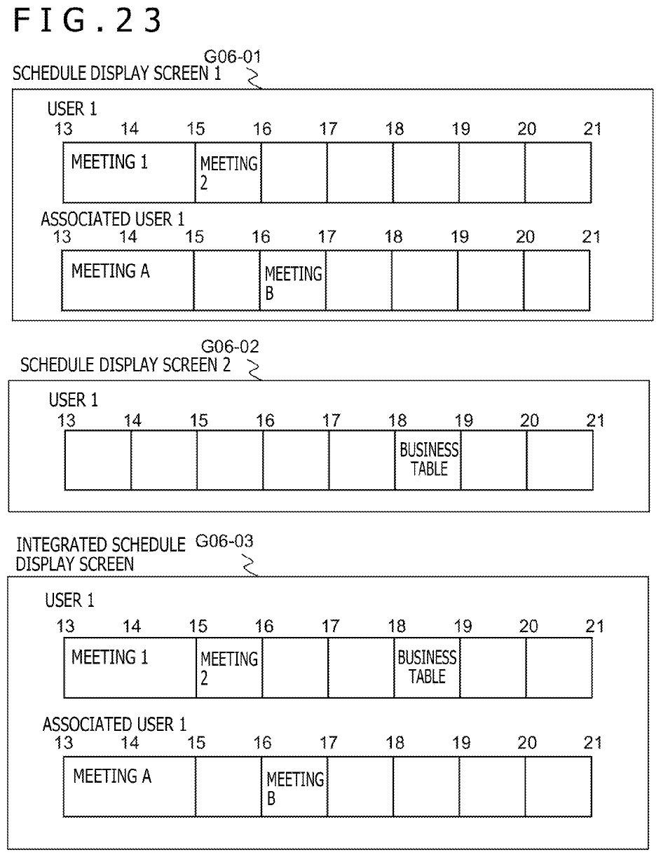

A state of generating the integrated associated schedule information from the associated schedule information will be described with reference to FIG. 23. It is assumed that user's schedules are managed by the schedule management server 1 (2-1) and the schedule management server 2 (2-2) as a content of, for example, the user's schedule in a company displayed on a schedule display screen 1 (G06-01) and as a content of the user's private schedule displayed on a schedule display screen 2 (G06-02). When an integrated schedule is generated from these two schedules by processing depicted by the timeline chart of FIG. 14, a schedule on an integrated schedule display screen (G06-03) is obtained. The integrated schedule has a content that entirely contains the own schedule of the user and the schedule of the associated user on the schedule display screen 1 (G06-01) and the schedule display screen 2 (G06-02).

One purpose of schedule integrated management is to adjust the schedules. Managing the schedules managed by the individual schedule management servers 2 as the integrated schedule makes it possible to easily grasp an unexecutable schedule that is difficult to notice by individual schedule management. A typical example of the unexecutable schedule is an overlap of a time zone between different schedules. Other examples of the unexecutable schedule include a case of executing two plans in different locations and a case in which the user is late for one plan due to lack of moving time. By checking schedule execution possibility and notifying the user of occurrence of an unexecutable schedule to encourage the adjustment of the schedules at the time of occurrence, it is possible to make effective use of time.

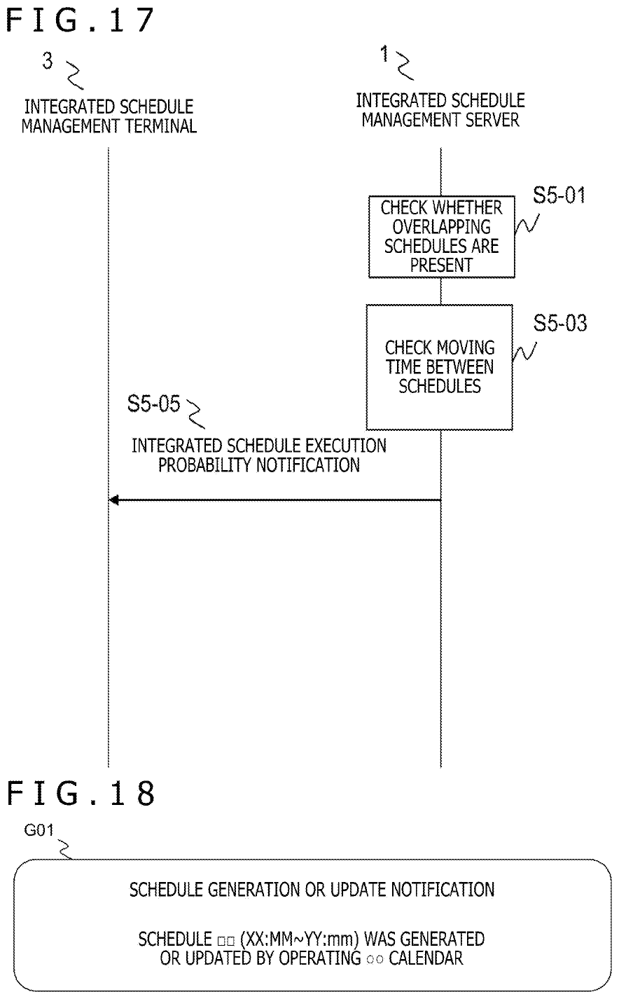

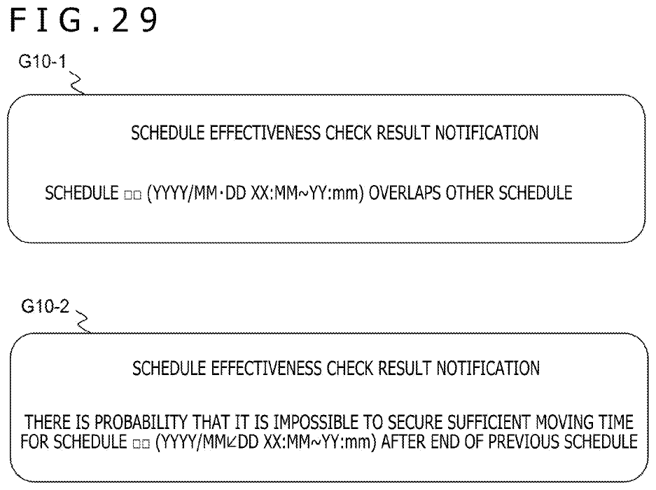

Processing for checking the schedule execution possibility and user notification processing will be described with reference to a timeline chart of FIG. 17. The execution possibility is checked by searching the integrated schedule information DB 165 by the integrated schedule management server 1. The integrated schedule management server 1 determines whether schedules having different integrated schedule identifiers and overlapping in a time zone are present in the user's integrated schedule (S05-01). Next, in a case in which the locations of the two different schedules differ, the integrated schedule management server 1 calculates time required for movement between the two locations and determines whether an unexecutable schedule is present (S5-03). In a case in which an unexecutable schedule is present, the integrated schedule management server 1 transmits an integrated schedule execution possibility notification to the integrated schedule management terminal 3 and notifies the user of presence of the unexecutable schedule (S5-05). FIG. 29 depicts examples of a notification screen (G10-1 and G10-2). The notification screen contains the intended schedules and a reason of the notification. The reason of the notification is either a schedule overlap or lack of the moving time.

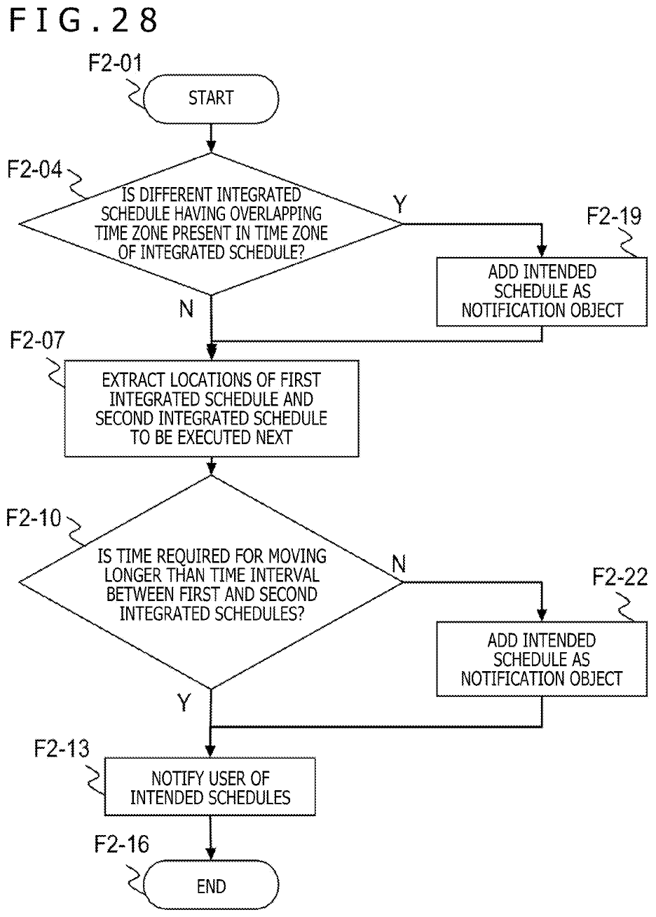

Schedule execution possibility determination processing will be described in detail with reference to a flowchart of FIG. 28. The integrated schedule management server 1 carries out the following processing using the schedules managed in the integrated schedule information DB 165 for each user. When the schedule execution possibility determination processing is started (F2-01), the integrated schedule management server 1 pays attention to one integrated schedule, and performs a search to confirm whether a different integrated schedule having an overlapping time zone either partially or entirely for the same user is present in the time zone of the integrated schedule to be checked (F2-04). In a case of presence of the different integrated schedule overlapping the integrated schedule to be checked in time (F2-04; Yes), the integrated schedule management server 1 adds the integrated schedule identifier of the integrated schedule having the overlapping time zone as a notification object (F2-19).

Next, the integrated schedule management server 1 searches a second integrated schedule to be temporally executed next to the intended integrated schedule, and extracts locations of the intended integrated schedule and the next integrated schedule (F2-07). The integrated schedule management server 1 then compares a time interval between these two schedules with a length of moving time between the locations corresponding to the two schedules (F2-10). In a case of determining that the time necessary to move between the locations is longer than the time interval between the schedules (F2-10; Yes), the integrated schedule management server 1 determines lack of the moving time and adds the second integrated schedule as a notification object (F2-22). The integrated schedule management server 1 then notifies the user of the integrated schedules that are all notification objects (F2-13) and ends the processing (F2-16). As for calculation of the time associated with movement between the locations, the time may be calculated by, for example, accessing the moving time search server 6 and an external website running a route search service or the like.

In this way, in the integrated schedule management system 1000 according to the present embodiment, the integrated schedule management server 1 is configured as an integrated schedule management apparatus including: a communication section that receives schedules of a user or/and a hardware box and associated schedules associated with the user or/and the hardware box from one or a plurality of management servers (for example, schedule management servers 2) via a network; and an integrated schedule management section (for example, integrated schedule management program 161) that generates an integrated schedule (for example, integrated schedule information DB 165) obtained by integrating the schedules (for example, schedule information DB 263) received from the one or the plurality of management servers for each of the user or/and the hardware box, and an integrated associated schedule (for example, integrated associated schedule information DB 167) obtained by integrating the associated schedules (for example, associated schedule information DB 267) received from the one or the plurality of management servers for each of the user or/and the hardware box, and that reflects the generated integrated schedule and the generated integrated associated schedule in the one or the plurality of management servers; therefore, it is possible to adjust the schedules of objects to be managed including hardware boxes and individuals including involved parties. Specifically, it is possible to realize schedule adjustment by taking into consideration the schedules of all involved parties and hardware boxes related to a plurality of schedule management systems, and reflect a result of the schedule adjustment in the individual schedule management systems in a format suited for the systems.

Furthermore, as depicted in FIGS. 15 and 16, the integrated schedule management section notifies the one or the plurality of management servers of information indicating a content of generation or a content of update at a time of generating or updating the integrated schedule and the integrated associated schedule; therefore, it is possible to grasp the individual schedules reflective of the result of the schedule adjustment. It is thereby possible to improve user's time utilization efficiency.

Moreover, as depicted in FIGS. 24 and 27, the integrated schedule management section controls a method of the notification according to generation sources and notification destinations of the integrated schedule and the integrated associated schedule, and a content of a schedule control parameter representing notification measures that are specified in a schedule control information database 169; therefore, it is possible to notify the user of the schedules by a user's desired method.

Furthermore, the schedule control parameter contains a set value indicating that the integrated schedule or the integrated associated schedule is set open or closed as the method of the notification, and the integrated schedule management section sets a content of the notification closed in a case in which the set value indicates closed; therefore, it is possible to eliminate a risk of making the schedules known in a case of user's not desiring the schedules are made open.

Moreover, the schedule control parameter contains a set value indicating that the method of the notification is unregistered, and the integrated schedule management section does not transmit the notification to the one or the plurality of management servers in a case in which the set value indicates that the method of the notification is unregistered; therefore, it is possible to exercise control in such a manner that the generated or updated schedules are not reflected in the one or the plurality of management servers.

Furthermore, the integrated schedule management section determines whether the integrated schedule or the integrated associated schedule overlaps a different integrated schedule or a different integrated associated schedule, and notifies a user terminal (for example, integrated schedule management terminal 3) of the overlapping schedule in a case of determining that the integrated schedule or the integrated associated schedule overlaps the different integrated schedule or the different integrated associated schedule; therefore, it is possible to easily grasp an unexecutable schedule that is difficult to notice in individual schedule management.

Moreover, the integrated schedule management section calculates moving time between locations of the integrated schedules or the integrated associated schedules determined not to overlap each other in a case of determining that the integrated schedule or the integrated associated schedule does not overlap the different integrated schedule or the different integrated associated schedule, and transmits the notification in a case in which the calculated moving time is shorter than a time interval between the integrated schedules or the integrated associated schedules determined not to overlap each other; therefore, it is possible for the user to grasp the unexecutable schedule by taking the moving time between the locations into consideration.

What is claimed is:

1. An integrated schedule management apparatus comprising:
a communication section that receives schedules of a user or/and a hardware box and associated schedules associated with the user or/and the hardware box from one or a plurality of management servers via a network; and
an integrated schedule management section that generates an integrated schedule obtained by integrating the schedules received from the one or the plurality of management servers for each of the user or/and the hardware box, and an integrated associated schedule obtained by integrating the associated schedules received from the one or the plurality of management servers for each of the user or/and the hardware box, and that reflects the generated integrated schedule and the generated integrated associated schedule in the one or the plurality of management servers.

2. The integrated schedule management apparatus according to claim 1, wherein
the integrated schedule management section notifies the one or the plurality of management servers of information indicating a content of generation or a content of update at a time of generating or updating the integrated schedule and the integrated associated schedule.

3. The integrated schedule management apparatus according to claim 2, wherein
the integrated schedule management section controls a method of the notification according to generation sources and notification destinations of the integrated schedule and the integrated associated schedule, and a content of a schedule control parameter representing notification measures that are specified in a schedule control information database.

4. The integrated schedule management apparatus according to claim 3, wherein
the schedule control parameter contains a set value indicating that the integrated schedule or the integrated associated schedule is set open or closed as the method of the notification, and
the integrated schedule management section sets a content of the notification closed in a case in which the set value indicates closed.

5. The integrated schedule management apparatus according to claim 3, wherein
the schedule control parameter contains a set value indicating that the method of the notification is unregistered, and
the integrated schedule management section does not transmit the notification to the one or the plurality of management servers in a case in which the set value indicates that the method of the notification is unregistered.

6. The integrated schedule management apparatus according to claim 1, wherein
the integrated schedule management section determines whether the integrated schedule or the integrated associated schedule overlaps a different integrated schedule or a different integrated associated schedule, and notifies a user terminal of the overlapping schedule in a case of determining that the integrated schedule or the integrated associated schedule overlaps the different integrated schedule or the different integrated associated schedule.

7. The integrated schedule management apparatus according to claim 6, wherein
the integrated schedule management section calculates moving time between locations of the integrated schedules or the integrated associated schedules determined not to overlap each other in a case of determining that the integrated schedule or the integrated associated schedule does not overlap the different integrated schedule or the different integrated associated schedule, and transmits the notification in a case in which the calculated moving time is shorter than a time interval between the integrated schedules or the integrated associated schedules determined not to overlap each other.

8. An integrated schedule management method carried out by an integrated schedule management system having one or a plurality of management servers and an integrated schedule management apparatus connected via a network, the integrated schedule management method comprising:
receiving schedules of a user or/and a hardware box and associated schedules associated with the user or/and the hardware box from the one or the plurality of management servers via the network;
generating an integrated schedule obtained by integrating the schedules received from the one or the plurality of management servers for each of the user or/and the hardware box, and an integrated associated schedule obtained by integrating the associated schedules received from the one or the plurality of management servers for each of the user or/and the hardware box; and
reflecting the generated integrated schedule and the generated integrated associated schedule in the one or the plurality of management servers.

9. The integrated schedule management method according to claim 8, wherein
the one or the plurality of management servers are notified of information indicating a content of generation or a content of update at a time of generating or updating the integrated schedule and the integrated associated schedule.

10. The integrated schedule management method according to claim 9, wherein
a method of the notification is controlled according to generation sources and notification destinations of the integrated schedule and the integrated associated schedule, and a content of a schedule control parameter representing notification measures that are specified in a schedule control information database.

11. The integrated schedule management method according to claim 10, wherein
the schedule control parameter contains a set value indicating that the integrated schedule or the integrated associated schedule is set open or closed as the method of the notification, and
a content of the notification is set closed in a case in which the set value indicates closed.

12. The integrated schedule management method according to claim 10, wherein
the schedule control parameter contains a set value indicating that the method of the notification is unregistered, and
the notification is not transmitted to the one or the plurality of management servers in a case in which the set value indicates that the method of the notification is unregistered.

13. The integrated schedule management method according to claim 8, wherein
determining whether the integrated schedule or the integrated associated schedule overlaps a different integrated schedule or a different integrated associated schedule, and
notifying a user terminal of the overlapping schedule in a case of determining that the integrated schedule or the integrated associated schedule overlaps the different integrated schedule or the different integrated associated schedule.

14. The integrated schedule management method according to claim 13, further comprising:
calculating moving time between locations of the integrated schedules or the integrated associated schedules determined not to overlap each other in a case of determining that the integrated schedule or the integrated associated schedule does not overlap the different integrated schedule or the different integrated associated schedule; and
transmitting the notification in a case in which the calculated moving time is shorter than a time interval between the integrated schedules or the integrated associated schedules determined not to overlap each other.
